(19) United States
(12) Patent Application Publication
(10) Pub. No.: US 2013/0239432 A1
(43) Pub. Date: Sep. 19, 2013

(54) APPARATUS AND SYSTEM FOR CONTROLLING THE TEMPERATURE OF OBJECTS

(71) Applicant: DUERR ECOCLEAN GMBH, Filderstadt (DE)

(72) Inventors: Hermann-Josef David, Monschau (DE); Egon Kaeske, Aachen (DE)

(73) Assignee: Duerr Ecoclean GmbH, Filderstadt (DE)

(21) Appl. No.: 13/887,990

(22) Filed: May 6, 2013

Related U.S. Application Data
(63) Continuation of application No. PCT/EP2011/068780, filed on Oct. 26, 2011.

(30) Foreign Application Priority Data
Nov. 5, 2010 (DE) 10 2010 043 522.8

(51) Int. Cl. F26B 21/00

(52) U.S. Cl. CPC F26B 21/003
USPC 34/480; 34/218

(57) ABSTRACT

An apparatus controls the temperature of objects such as workpieces after a cleaning operation. The apparatus has a controlled temperature zone (14), which is formed as a cooling and/or heating zone and in which the objects can be subjected to an incident flow of gaseous fluid. The controlled temperature zone (14) is formed in a chamber (12) which can be subjected to a fluid flow (58) which flows into the chamber (12).

### CROSS REFERENCE TO RELATED APPLICATIONS

This application is a continuation application of international patent application PCT/EP2011/068780, filed Oct. 26, 2011, designating the United States and claiming priority from German application 10 2010 043 522.8, filed Nov. 5, 2010, and the entire content of both applications is incorporated herein by reference.

### FIELD OF THE INVENTION

The invention relates to an apparatus and system for controlling the temperature of objects, in particular of workplaces, after a cleaning operation, in that the latter are subjected to an incident flow of gaseous fluid after the cleaning operation. The invention also relates to a method for controlling the temperature of the objects.

### BACKGROUND OF THE INVENTION

For the quality and reliability of industrially produced products, it is important that workpieces in corresponding production processes are clean. In industry, use is therefore made of cleaning systems with liquid baths. In these baths, the workpieces are flushed in order to free them of swarf, lubricant, dust and chemicals. A good cleaning action can be achieved in this case in particular with hot cleaning liquids. The workpieces are heated in such cleaning liquids. It is then often necessary for steps In the production process which follow the cleaning that workpieces or else subassemblies are cooled. In modified processes, however, reverse operations can also be provided, in which a cooling operation is followed by a process-related (re)heating operation.

For controlling the temperature (cooling and/or heating) of workpieces in industrial production facilities, devices are known in which workpieces are moved through a tunnel continuously or in a clocked manner by means of a conveying system. In the tunnel, the workpieces are subjected to a temperature-controlled air flow. Here, however, there is the risk that cleaned workpieces become contaminated again, because dirt particles are often carried along in a temperature-controlled air flow owing to various treatment operations and fed to the tunnel. If the air flowing in such a tunnel has to be cooled with cooling units or heated with heaters, the operation of such devices additionally also leads to a high energy consumption.

### SUMMARY OF THE INVENTION

It is an object of the invention to provide an apparatus and a system for controlling the temperature of objects, in particular of workpieces for use in an industrial production facility, which makes it possible to efficiently control the temperature of objects and workpieces without considerable contamination.

This object is achieved by an apparatus of the type mentioned above wherein a controlled temperature zone is formed as a cooling and/or heating zone and is formed in a chamber which can be subjected to a fluid flow which flows into the chamber.

The invention is based on the concept that objects, in particular workpieces, can also be cooled with the air flow which is circulated in a clean-room cell. The invention exploits the fact that the risk of contamination of workpieces by an air flow in such a clean room is not present if the supplied air to such a clean-room cell is filtered in order to keep the particle size and particle concentration in the cell below a predefined threshold value.

One concept of the invention is in particular that, by circulating purified gaseous fluid in a chamber, workpieces can be cooled in a manner which saves energy if the workpieces are subjected to an incident flow of slowly flowing fluid, for example, air, in the chamber over a relatively long time (for instance half an hour, several hours or even days). It is also a concept of the invention to move workpieces between spaced-apart production stations for efficiently cooling an industrial production facility in a clean-room cell with a circulated air flow.

In a further configuration of the invention, the controlled temperature zone is designed as a cooling and/or heating zone, wherein the controlled temperature zone is arranged in a chamber which is thermally insulated with respect to the environment, and wherein a fluid flow flows into the chamber through a filter preferably formed as a fine filter, in particular through a HEPA filter. A HEPA filter of the filter class H10 or higher in accordance with the European standard EN 18 22-1:1998 is preferably chosen as the filter in an apparatus according to the invention. Extremely small particles having a size of down to in the region of 0.3 μm can be filtered out in a HEPA filter. A HEPA filter therefore makes it possible in particular to free room air of fine dust, tobacco smoke, smoke, house dust, pollen, pores and odors. With a HEPA filter, it is possible to achieve overall degrees of separation of 99.9% for fine dust and suspended matter, that is, of 10000 dust particles, only three are not separated in a corresponding HEPA filter. A HEPA filter can be made up of a fine-mesh fabric of cellulose, synthetic fibers or glass fibers. Such fabrics are laid one on top of another with up to 1000 layers in a filter according to the invention. This provides a very large filter area. A particularly good filter action can be achieved by combining the HEPA filter with an activated carbon filter. This activated carbon filter is advantageously provided upstream of the HEPA filter. A pressure which is elevated compared to an ambient pressure (excess pressure) can be generated in the chamber by feeding in filtered, gaseous fluid. This ensures that no dust particles, dirt particles and liquid droplets can penetrate into the chamber from the outside from the environment.

In order that a fluid flow suitable for heating and/or cooling forms in the chamber, it is advantageous if the fluid flow flowing into the chamber through the filter is guided to at least one suction opening connected to the line system in the chamber. The fluid flow preferably flows in via the cover of the chamber. It advantageously runs through the controlled temperature zone to a suction extraction opening formed on a lateral portion of the chamber in the region of the bottom thereof. It is advantageous in particular if the flow of the fluid flow has an arc form in the controlled temperature sons.

In a further configuration of the invention, the chamber is connected to a line system for feeding gaseous fluid to the chamber and for carrying gaseous fluid away from the chamber and also for circulating the gaseous fluid in a circuit formed by way of the line system. In particular, it is a concept of the invention to circulate gaseous fluid for cooling or heating workpieces in a largely closed line system with a circuit. A heat exchanger for transferring heat into the fluid or out of the fluid is preferably provided in such a largely closed circuit, in which preferably more than 90% of the fluid is circulated. Fluid which is fed to the circuit is preferably pumped through a filter and introduced into the circuit at an elevated pressure compared to the environment.

A pump device is arranged in the line system for circulating fluid. This pump device can be formed, for example, as a Venturi nozzle connected to the compressed air system of an industrial production installation. A suitable pump device is also, however, a fan or compressor driven by electric motor. Using such a pump device, the gaseous fluid is sucked into the chamber through one or more suction openings and then fed to the filter. It is advantageous if the pump device is connected, to a further feed duct for feeding gaseous fluid into the line system. It is then possible in particular for an overpressure to be generated in the chamber. This has the effect, that no dust particles, dirt particles and liquid droplets can penetrate into the chamber from the outside from the environment.

It is advantageous in particular if the chamber is accommodated with the line system for circulating fluid in a transporting cabinet in the form of a container. In order that the apparatus can be moved in a simple manner in an industrial production facility, it is advantageous to provide this transporting cabinet or container with transporting elements in the form of rollers so that it can foe moved easily in the hall of a production facility. A transporting cabinet designed as a container preferably comprises transporting elements in the form of a means or a plurality of means nor the engagement of a fork of a forklift truck. With this measure, it is not only possible to control the temperature of workplaces as they are being moved between different production stations, but also an undesirable contamination of workpieces as they are being transported to stations in an industrial production facility is avoided. In order to make it possible here for fluid to be circulated even without connection to an electrical supply system, it is advantageous to integrate an electrical energy store, for example, a storage battery, in the transporting cabinet for operating a fan.

The chamber contains a holding device with a plurality of workpiece holders for receiving workpieces which are to be controlled in terms of temperature, in particular cooled. This holding device serves to hold the workpieces in the controlled temperature zone. If the chamber is formed with a columnar housing, this holding device can have, for example, workpiece holders with round storage bases, on which corresponding workpieces can be deposited. For the movement of such round storage bases in the chamber, the apparatus for cooling may have a drive. It is advantageous if the workpiece holders are formed for the cascading arrangement of the workpieces offset in relation to one another in the fluid flow. This has the effect that dirt, particles removed from a workpiece with the fluid flow are not carried to another workpiece and do not contaminate it in the controlled temperature zone.

In order to carry away the quantity of fluid moving via the further feed duct into the chamber, there are one or more openings for releasing gaseous fluid to the environment in the chamber. This ensures that dirt particles are flushed from the cooling zone of the chamber to the outside.

It is advantageous to arrange at least one flushing nozzle for flushing out the chamber with flushing liquid in the chamber. This makes it possible to easily and systematically clean the chamber of dirt particles. It is advantageous if the chamber has a device for collecting flushing liquid which has been fed into the chamber. This device for collecting flushing liquid which has been fed into the chamber can be connected to an installation for processing flushing liquid.

The apparatus for cooling objects and workpieces can be used, for example, as a clean room or else as an unload lock in final assembly. However, the apparatus for cooling is also suitable as a buffer store for workpieces in a production facility, in order to thereby set a consistent feed of workpieces. For loading objects, in particular workplaces, into and unloading them from the apparatus, the latter can be combined in particular with a handling robot to form a system. It is advantageous to feed objects or workpieces for cooling to the apparatus via a lock, such that no dirt particles are introduced into the cooling zone of the chamber.

With the apparatus or system for temperature control, the temperature of workpieces can be controlled between two production steps in an industrial production facility. For this purpose, for example, after a production step in a first production station and before a further production step in a second production station spatially separated from the first production station, a plurality of workpieces are arranged in the chamber having the controlled temperature zone. The workpieces arranged in the chamber are subjected there to an incident flow of gaseous fluid filtered by way of a fine filter in such a manner that dirt particles removed from a workplace with the gaseous fluid are not carried to another workpiece by the gaseous fluid. In this respect, it is possible in particular to move the workpieces in the chamber from the first production station to the second production station as the temperature is being controlled.

### BRIEF DESCRIPTION OF THE DRAWINGS

The invention will now be described with reference to the drawings wherein:

FIG. 1 is a first view of an apparatus for cooling workpieces;

FIG. 2 shows the apparatus for cooling workpieces with an additional handling apparatus;

FIG. 3 is a section view of the apparatus for cooling workpieces taken along line III-III of FIG. 1; and,

FIG. 4 is a section of the apparatus along the line IV-IV of FIG. 1.

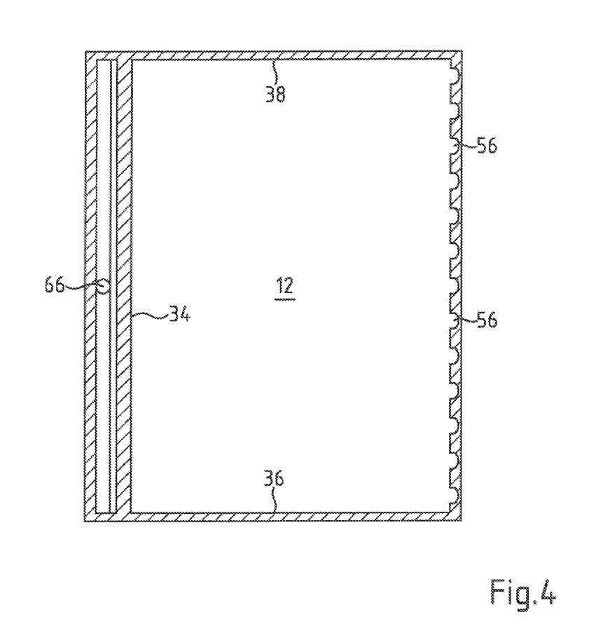

### DESCRIPTION OF THE PREFERRED EMBODIMENTS OF THE INVENTION

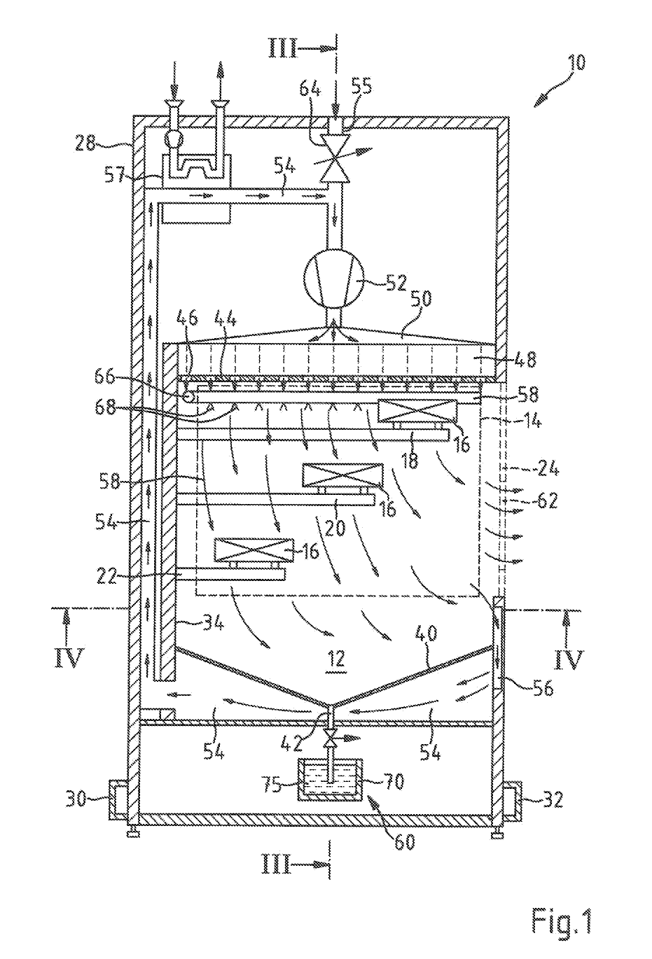

An apparatus 10 for controlling the temperature of workpieces 16 as shown in FIG. 1 has, according to a feature of the invention, a chamber 12. The chamber 12 is located in a container 28 formed as a transporting cabinet. The chamber 12 surrounds a controlled temperature zone 14 in the form of a cooling zone, in which workpieces 16 can be cooled proceeding from an elevated temperature compared to ambient conditions.

The apparatus 10 contains a holding device for workpieces 16, which has a plurality of workpiece holders (18, 20, 22). In the chamber 12, workpieces 16 can be arranged on the workpiece holders (18, 20, 22) in the cooling zone 14 in a manner spatially offset in the manner of a cascade.

The transporting cabinet 28 has a sliding door 24, The sliding door 24 can close off the chamber 12 so as to avoid the penetration of dirt particles into the cooling zone 14. On that side, which lies opposite the sliding door 24, the chamber 12 in the apparatus 10 has a closed wall 34. The chamber 12 is accommodated in a container 28. The container 28 has handling elements (30, 32). At the handling elements (30, 32), the container 28 can be held with the fork of a forklift truck. This makes it possible to move the container 28 in an industrial production installation. In order to make it possible for the container to be moved in a production facility, it is also possible, however, to mount the container 28 on rollers.

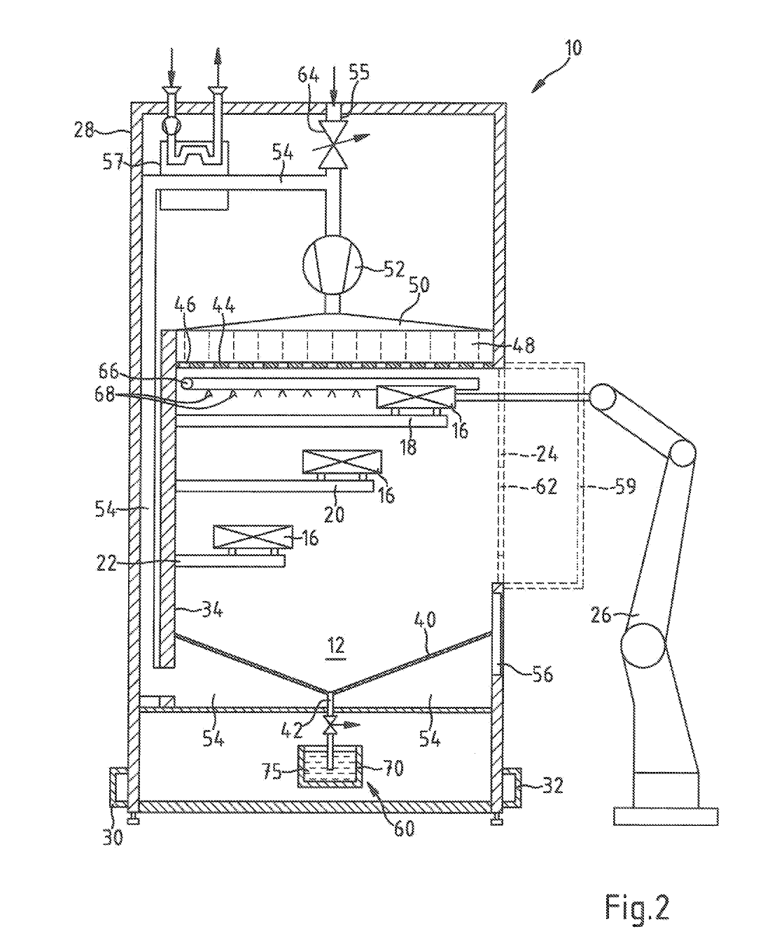

FIG. 2 shows the apparatus with an opened sliding door 24 and a handling robot 26. Through the opened sliding door 24, the handling robot 26 can be used to load the chamber 12 with workpieces 15 which have to be cooled. Correspondingly, cooled workpieces 16 can be removed from the chamber 12. The introduction of dirt particles into the chamber 12 can be minimized by loading the workpieces 16 into the chamber 12 through an air lock 59.

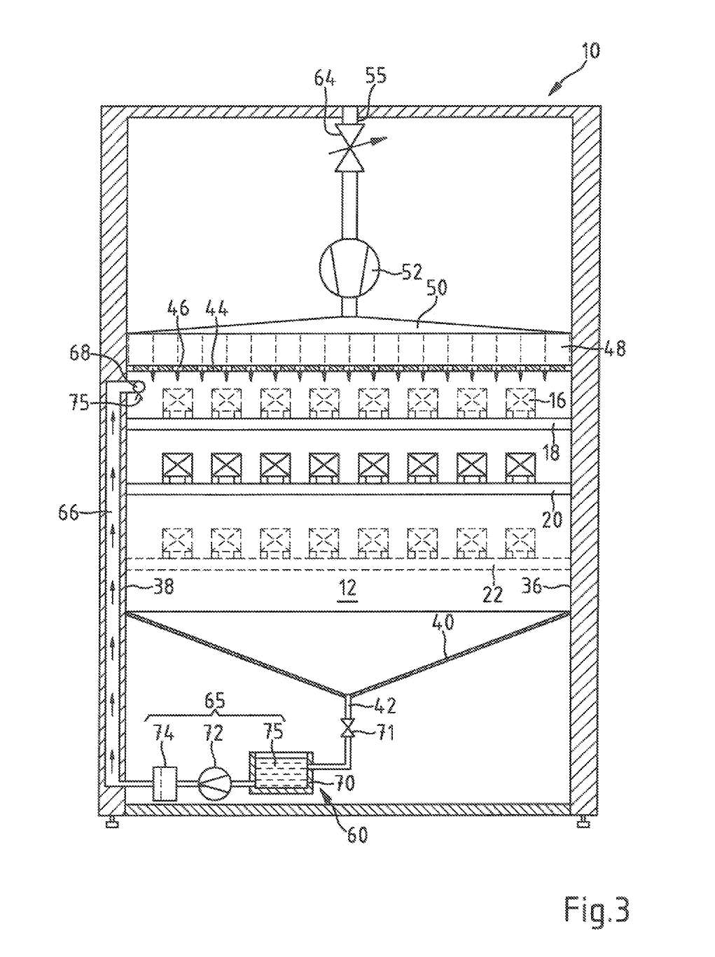

FIG. 3 shows the apparatus 10 as a section along the line III-III shown in FIG. 1. The side walls (36, 38) of the chamber 12 which adjoin the wall 34 are also closed. The chamber 12 is formed with a bottom portion 40. The bottom portion 40 is funnel-shaped. The funnel-shaped bottom portion 40 opens into a pipeline 42. The funnel-shaped bottom portion 40 acts as a device for collecting flushing liquid 75 which has been fed into the chamber 12.

The chamber 12 has a cover 44. There are openings in the form of air ducts 46 in the cover 44. A HEPA filter 48 (High Efficiency Particulate Air Filter) is arranged on the cover 44, The HEPA filter 48 is a fine-mesh ultrafine filter. It is a filter of the filter class H10 in accordance with the European standard EN 1822-1:1998.

The apparatus 10 contains a fan 52. The fan 52 is arranged in a line system 54 for circulating gaseous fluid in the form of air in the chamber 12. The gaseous fluid can be circulated in particular in the manner of a circuit through the line system 54. At its pressure-side connection, the fan 52 is connected to the HEPA filter 48 by way of a funnel-shaped line portion 50. For the dissipation of heat which the gaseous fluid has absorbed in the cooling zone 14, there is a heat exchanger 57 in the line system 54. This heat can be carried away to the area surrounding the apparatus 10 by means of the heat exchanger 57.

The HEPA filter 48 can be subjected to blowing air by the fan 52 by way of a funnel element 50. The line system 54 is connected to a feed duct 55 for ambient air. A controllable valve 64 is arranged in the feed duct 55. By setting the valve 64, ambient air can be added in a controlled manner to the circulating air conducted in the line system 54. This makes it possible to set an overpressure in the chamber 12 by means of the fan 52. This has the effect that no dust particles, liquid droplets and dirt particles can penetrate into the chamber 12 from the outside. There are suction extraction openings 56 for gaseous fluid in the chamber 12. The suction extraction openings 56 are connected to the line system 54. An air flow 58 with filtered air is formed in the chamber 12 upon operation of the fan 52. The HEPA filter 43 filters dust, liquid or dirt particles from air, which pass from the line system 54 into the chamber 12. The air flowing in via the ducts 46 in the cover 44 is moved through the chamber 12 with an arc-shaped flow.

With the arc-shaped flow, the air flows to the suction extraction opening 56 and to openings 62 in the sliding door 24. The continuous feed of air through the HEPA filter 48 sets an overpressure in the chamber 12. This overpressure ensures that no air contaminated with liquid droplets and dirt particles can penetrate into the chamber 12 from the outside.

The arc-shaped flow of the air flowing through the chamber 12 makes it possible to cool workpieces 16 which are arranged on the holders 18, 20 and 22. The arrangement of the workpieces 16 in the chamber 12 in the manner of a cascade ensures that a workpiece 16 in the chamber 12 does not shade the air flow for another workplace 16, and therefore each workpiece arranged in the chamber 12 can be subjected to an incident flow of air for cooling.

With the apparatus 10, it is also possible for the degree of contamination of workpieces 16 in the chamber 12 to be improved by virtue of the air flowing in accordance with the flow 58. Unlike in conventional apparatuses for cooling workpieces, the degree of contamination when cooling workpieces with gaseous fluid is thus reduced, that is, in no way impaired.

In order to remove dirt particles which are introduced into the chamber 12 by way of the workpieces 16 from the chamber 12, there is a device 60 for flushing out the chamber with flushing liquid 75. The device 60 comprises a line system 66. The line system 66 connects flushing nozzles 58, which are arranged in the chamber 12, to a reservoir 70 for the flushing liquid 75. The reservoir 70 is connected with the pipeline 42 to the chamber 12 at the funnel-shaped bottom portion 40 by way of a shut-off valve 71.

The device 60 contains an assembly 55 for processing flushing liquid 75. The assembly 65 includes a flushing pump 72 and a filter 74. For flushing out the chamber 12 with flushing liquid 75, the flushing pump 72 is activated. Then, dirt particles which have deposited on the closed walls (34, 36, 38) are flushed away with the flushing liquid 75 flowing out of the flushing nozzles 68, and carried into the reservoir 70 by way of the funnel-shaped bottom portion 40. The dirt particles are removed from the flushing liquid 75 here by the filter 14 upon circulation of the flushing liquid 75.

In an industrial production facility, the apparatus 10 can be used in particular for transporting workpieces 16 between two or more different production stations and/or as a buffer store for workpieces 16 at a production station.

In summary, the following preferred features of the invention are noted in particular: an apparatus 10 for controlling the temperature of objects, in particular of workpieces 16, after a deeming operation has a controlled temperature zone 14, which is formed as a cooling and/or heating tone and in which the objects 16 can be subjected to an incident flow of gaseous fluid. The controlled temperature zone 14 is formed in a chamber 12 which can be subjected to a fluid flow 58 which flows into the chamber 12.

It is understood that the foregoing description is that of the preferred embodiments of the invention and that various changes and modifications may be made thereto without departing from the spirit and scope of the invention as defined in the appended claims.

What is claimed is:

1. A method for controlling the temperature of a plurality of objects including workpieces in an industrial production facility wherein the objects are moved from a first production station to a second production station, the method comprising:
providing a chamber defining a controlled temperature zone;
loading said objects into said chamber in said controlled temperature zone;
passing a flow of gaseous fluid through a fine filter;
subjecting said objects to the filtered flow of gaseous fluid in said controlled temperature zone; and,
after a production step at said first production station and before a further production step at said second production station spatially separated from said first production station, moving said objects from said first production station to said second production station while simultaneously controlling the temperature of said objects in said temperature zone.

2. The method of claim 1, comprising the further step of directing the flow of said gaseous fluid so as to cause dirt removed from one object not to be carried to another object.

3. The method of claim 2, wherein said plurality of objects are heated or cooled in said controlled temperature zone.

4. The method of claim 1, comprising the further steps of:
equipping said chamber with a cover and said fine filter;
causing said gaseous fluid to flow into said chamber via said fine filter and said cover; and,
providing a plurality of holders in said chamber for corresponding ones of said objects with said holders being placed so as to effect a cascading arrangement of said objects when the objects axe offset in relation to one another in said flow of gaseous fluid.

5. The method of claim 4, wherein said filter is a HEPA filter.

6. The method of claim 4, comprising the further steps of:
providing a suction extraction opening formed on a lateral portion of said chamber in the region of the bottom thereof; and,
causing said flow of gaseous fluid passing via said filter and said cover into said chamber to pass through said controlled temperature zone in an arc-shaped flow to said suction extraction opening.

7. The method of claim 6, comprising the further step of providing a device in said chamber for flushing out said chamber with a flushing liquid.

8. The method of claim 7, wherein dirt particles become entrained with said flushing liquid and said method comprises the further steps of:
providing a collecting device for collecting said flushing liquid fed into said chamber and providing a processing device for processing the collected flushing liquid with said processing device being connected to said collecting device; and,
equipping said processing device with a filter for filtering out said dirt particles in said flushing liquid.

9. The method of claim 8, comprising the further steps of:
providing a movable transport cabinet wherein said chamber and said processing device are accommodated; and,
equipping said movable transport cabinet with a transporting element for moving the transport cabinet.

10. The method of claim 9, wherein said transporting element includes at least one of a roller and an engagement for the fork of a forklift truck.

11. The method of claim 1, comprising the further step of providing a conduit system through which the gaseous fluid is supplied to said chamber and through which the gaseous fluid can be conducted away from said chamber; and, said conduit system defining a circuit for circulating the gaseous fluid.

12. The method of claim 11, comprising the further step of providing a pump device arranged in said conduit system for drawing the gaseous fluid through at least one suction opening into said chamber and feeding the gaseous fluid to said fine filter.

13. The method of claim 12, wherein the pump device is formed as a fan or as a venturi nozzle arranged in said conduit system.

14. The method of claim 12, comprising the further step of providing a feed duct for feeding the gaseous fluid into said conduit system in order to generate an overpressure in said chamber.

15. The method of claim 11, comprising the further steps of:
providing a movable transport cabinet for accommodating said chamber therein;
adapting said conduit system for circulating said gaseous fluid in said transport cabinet; and/or,
configuring said conduit system to include a heat exchange for supplying or carrying away heat to be exchanged with the gaseous fluid in said controlled temperature zone.

16. The method of claim 1, wherein said chamber has at least one opening for releasing gaseous fluid to the ambient.

17. The method of claim 1, wherein the objects are buffer-stored in said chamber in said industrial production facility.

18. The method of claim 1, comprising the further steps of loading and unloading said objects into said chamber and unloading said objects from said chamber with a handling apparatus including an industrial robot.

19. The method of claim 18, wherein said objects are loaded into said chamber through a lock connected to said chamber.

20. An apparatus for controlling the temperature of a plurality of workpieces, the apparatus comprising:
a chamber defining a controlled temperature zone;
a conduit system connected to said chamber so as to pass a flow of a gaseous fluid through said chamber;
a plurality of holders for holding corresponding ones of said workpieces in said chamber so as to cause said flow of gaseous fluid to incident thereon; and,
said holders being spatially arranged in said chamber to prevent dirt removed from one of said workpieces to be carried to another one of said workpieces by said flow of gaseous fluid.
